(19) United States
(12) Patent Application Publication
(10) Pub. No.: US 2025/0190938 A1
(43) Pub. Date: Jun. 12, 2025

(54) SYSTEM AND METHOD FOR LINEN MANAGEMENT AND DISTRIBUTION IN AN ACCOMMODATION ENVIRONMENT

(71) Applicant: A-WORK SERVICES PTY LTD, Belmont (AU)

(72) Inventor: Choon Ming TANG, Burwood East (AU)

(21) Appl. No.: 18/712,501

(22) PCT Filed: Sep. 1, 2023
(86) PCT No.: PCT/AU2023/050857

§ 371 Date: May 22, 2024

(30) Foreign Application Priority Data
Sep. 2, 2022 (AU) 2022902534
Sep. 2, 2022 (AU) 2022902535
Sep. 2, 2022 (AU) 2022902536
Sep. 2, 2022 (AU) 2022902537

(51) Int. Cl. G06Q 10/087; G06K 19/07; G06Q 10/083; G06Q 50/12

(52) U.S. Cl. CPC G06Q 10/087; G06K 19/0723; G06Q 10/083; G06Q 50/12

(57) ABSTRACT

The present invention relates generally to a linen management system and method for managing the flow of linen in an accommodation environment, and in particular, to a linen management system with an enhanced distribution methodology for managing the flow of linen supply in an accommodation environment through the use of automated robotics and RFID system.

### RELATED APPLICATIONS

The present application claims priority from Australian Provisional Patent Application No. 2022902534 filed 2 Sep. 2022, Australian Provisional Patent Application No. 2022902535 filed 2 Sep. 2022, Australian Provisional Patent Application No. 2022902536 filed 2 Sep. 2022 and Australian Provisional Patent Application No. 2022902537 filed 2 Sep. 2022, the entire contents of which are incorporated herein by reference.

### FIELD OF INVENTION

The present invention relates generally to a linen management system and method for managing the flow of linen in an accommodation environment, and in particular, to a linen management system with an enhanced distribution methodology for managing the flow of linen supply in an accommodation environment through the use of automated robotics and RFID system.

### BACKGROUND OF THE INVENTION

In accommodation environments, such as hotels, motels, and the like, there is a constant need to replace soiled linen in a timely manner to ensure that guests are served with an appropriate level of quality. In the hospitality industry, linen generally includes fabric household goods that are intended for daily use, such as bedding items, tablecloths, towels and the like. As the linen in such environments requires regular changing and cleaning, management of the supply of linen to rooms and other spaces together with the collection and cleaning of soiled linen requires significant attention to detail. This is especially a problem in periods of high occupancy, as there may be very little time for housekeeping staff to set up a room between the guests checking out and the new guest checking in.

For housekeeping staff to complete their tasks in an efficient and timely manner, there is a need to manage the flow of linen to and from the rooms. By distributing the appropriate amount of clean linen to the desired location, enables the housekeeping staff to complete their tasks in an efficient manner. This requires control, not only of the amount and type of linen required, but also the timing of the delivery to be present at the desired collection point.

In most existing hospitality environments, the housekeeping staff generally strip the soiled linen from each room before depositing the soiled linen into the soiled linen chute or trolleys for collection. The housekeeping staff then typically collect the required clean linen from a designated storage room to prepare the room for new guests. Such a system requires considerable manual effort on behalf of the housekeeping staff and requires that they collect the correct amount of replacement clean linen to complete the task, and in some instances the housekeeping staff may require multiple trips to the designated storage room, which can significantly increase the time taken to prepare a room.

Thus, in most accommodation businesses, the time taken by the housekeeping staff to strip and prepare a room generally takes considerably more time due mainly to a mismatch of linen available at each clean linen storage room. This may result in the housekeeping staff to attend multiple storage rooms across multiple floors in the building to source the appropriate linen for their needs. Generally, there are a variety of reasons attributed to the undersupply or oversupply of cleaned linen stored in such dedicated storage rooms. Typically, it is due to a lack of planning and knowledge of the flow of cleaned linen within a building. Irrespective of the reason, clean linen stock inconsistency leads to inefficient operations, consuming the valuable time of housekeeping staff.

The timeliness and accuracy of linen delivery to the accommodation site is another source of operational inefficiencies at the accommodation site. For commercial laundry facilities that service large hotel chains, there is a constant daily flow of laundry items that need to be cleaned and processed for quick return to their origin. In such applications, the main material flow is linen; however, there are a variety of other materials and items present in the production floor of such facilities that impact the ability of the facility to meet their delivery requirements. This is largely due to the presence of trolleys and other devices required to contain and transport the laundry to the required workstation within the cleaning facility. Therefore, when such a large volume and variety of items require processing in short time frames, it is difficult to manage the flow of materials through the facility which often results in production losses and delivery disruptions.

In most commercial laundry facilities, soiled linen will accumulate at a customers' location and it is typically the responsibility of the laundry facility to collect the soiled linen in accordance with an agreed schedule established with the customer. Once collected, typically by dedicated collection vehicles, such as trucks or vans, the soiled linen is delivered to the laundry facility for processing. Typically the soiled laundry is provided in trolleys or bags that are unloaded into a dedicated quarantine area at the laundry facility, where they are inspected and/or identified to determine the next processing step. The trolleys or linen bags are typically used as the medium of transport and they will be moved around the facility before the soiled linen is unloaded for sorting processes. As a result of this, the laundry items typically undergo multiple handling steps before they are processed, which introduces many inefficiencies within the process that increase the processing time and the reduce the efficiency of staff.

The sorting of the linen within the laundry facility is mostly done manually with each type of linen being identified by staff before they are segregated into bin compartments for washing, drying and eventually being finished off at the ironing and folding stations. The cleaned linen is then typically being packed according to requirements generally dictated by the customer, after which they are stored into trolleys and/or other storage means, before being dispatched to the customer in accordance with the customer's requirements.

Typically, when the trolleys or bags have been emptied of soiled laundry, they also require cleaning after which they are stored in a buffer location awaiting reuse. Due to the large volume of trolleys and bags and the variety of points at which they are taken to release the soiled laundry, they are often distributed throughout the facility in a random manner which can cause traffic congestion within the facility as well as occupying premium space in a generally crowded environment. As trolleys may come in a variety of sizes and shapes, their presence on the processing floor can have a significant detrimental effect on the ability of the facility to meet its time constraints in dispatching cleaned laundry to the customers.

Further to this, when the stored clean linen is ready for dispatch to the customer, the dispatch team will often need to re-pack the linen in accordance with the specific order requirements of the customer. Typically, once the cleaned linen has been packed to the request of an order, the packed trolley will then be parked at the loading bay waiting for the dispatch driver to pick up for delivery to the customer. Such double-handling of cleaned linen due to repacking often creates “leftover” items and half-filled trolleys. This can also further clutter the dispatch area of the facility and result in displaced linen as well as trolleys that are not being fully utilized.

In addition, the logistical challenges of coordinating such a system across multiple organisations can be surmountable, each with their own unique sets of logistic rules, requirements, and structure. In such applications, there are several interrelated variables that need to be coordinated. These include the means for loading and unloading the goods upon collection or delivery, availability of space to receive the goods upon collection or delivery, such as loading bays and buffering zones for accommodating the goods. The inability to correctly define and plan for such variables can significantly impact the efficiency of the system and the viability of the business.

The dynamic movements of the goods at loading/unloading bays can significantly impact the productivity of the transport drivers and at times the drivers may fail to meet their delivery goals due to inadvertent distractions. This may then have further flow-on effects resulting in the failure of the linen being delivered or picked up, leading for further inefficiencies of the housekeepers.

To achieve a successful management of a commercial laundry facility, it requires careful but detailed control of a variety of tasks to ensure high productivity level with and wastage reduction. When a laundry operates with the right prioritization and scheduling of linen types through the providence of customer's supplied information, the laundry's output will be optimized to minimize production interruption which often create unnecessary bottlenecks downstream that could “jerk” the line with unwanted linen in a wrong priority sequencing leading to shortages of trolleys, poor utilization of floor space and additional labour hours to handle over produced clean linen. Incorrect prioritization of clean linen will manifest into delivery delays causing much anxiety to the staff and customer alike.

The impact of such mismanagement can prolong delays to several days as the factory seeks to gradually recover from such mishaps.

Thus, there is a need to provide a linen management and distribution system that can integrate the entire linen supply chain and optimizes the material flow to achieve the best possible outcome to reduce overall costs and wastages.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### STATEMENT OF INVENTION

The invention according to one or more aspects is as defined in the independent claims. Some optional and/or preferred features of the invention are defined in the dependent claims.

The present invention aims to introduce a computerised management system integrate an array of automated equipment, robotics and RFID sensors and devices to allow a smooth handshake of materials often accompanied with software verification system in place to ensure all linen is identified correctly before processing. The system will manage data and information captured through these specially designed devices and disseminate vital instructions to the production system at the laundry plant, transportation systems, and the automated dispatching system at the laundry and client's site. The system will be integrated to the hotel's PMS (Property Management System) to allow certain check-out information being shared between the accommodation provider and the laundry. With this information sharing, the production system can then choose the right material flow path for each type of the linen, pack the orders according to the hotel's needs instantaneously thus eliminating the double handling of linen. The linen will be tagged with a unique ID for verification purposes and will be transported using an RFID tracked dedicated box as a carrying or storage medium. This tracking of linen in the boxes will minimise the likelihood of drivers missing any items when they perform a set of delivery tasks associated with a pick-up and delivery to multiple locations. The box system will fit purposefully in a well-defined rack system within a truck. The racking system will be provided with a loading and unloading lifter that can be connected to a purpose-built flexible mobile conveyor which will be used as an interim box movement system at the loading/unloading bay. The interactive use of the flexible mobile conveyor which links the box to the box bay system will allow the robotic equipment at accommodation sites to serve its purpose of delivering the boxes to their intended location within the premise. A double rack system inside the truck will ensure maximum use of the truck tray spaces to maximize each delivery route productivity on the road. There will be an integrated storage system for the carrying medium at the laundry plant. The inventory system for the carrying medium will have a sanitizing unit to ensure they are sanitized according to the standards available before being distributed back to the dispatching area for packing.

With the fully integrated management system and methodology being defined for its purpose and its use, and along with a sophisticated software algorithm, the forward-looking system will operate with high efficiency and accuracy to achieve the best outcome for both the laundry and the end customers.

Accordingly, in one aspect of the invention there is provided a laundry management system (LMS) for an accommodation facility comprising:
an accommodation management system for controlling movement of soiled and cleaned laundry within the accommodation facility;
a control system for interrogating a property management system of the accommodation facility to generate a cleaned laundry order in accordance with accommodation requirements of the accommodation facility;
a plurality of boxes, each box configured to store an order of either cleaned or soiled laundry, each box having a tag for identifying the box and the contents of the laundry contained therein;
a transportation system for collecting soiled laundry from the accommodation facility and for delivering cleaned laundry to the accommodation facility in accordance with the generated cleaned laundry order, the transportation system comprising at least one transport vehicle having a racking system contained therein, the racking system being configured to receive the boxes in a controlled manner and having a reader device for reading a tag of each box to record the presence of the box with the vehicle;
a conveyor system configured to engage with the vehicle to facilitate loading/unloading of the boxes from the racking system of the vehicle;
a cleaning centre for receiving boxes containing soiled laundry and for cleaning the soiled laundry and the boxes and for repacking the boxes with cleaned laundry, whereby individual cleaned laundry items are tagged to identify the cleaned laundry items in the repacked boxes in accordance with the generated cleaned laundry order;
an inventory buffer and racking system located at both the cleaning centre and the accommodation facility to receive the boxes, wherein the inventory buffer and racking system comprises one or more robotic carriers to facilitate movement of the boxes from the inventory buffer and racking system and within the accommodation facility.

In one embodiment of this aspect of the invention, the cleaned laundry order is generated by the control system at a predetermined time period before a room of the accommodation facility is to be vacated. The predetermined time period may be 24 hours. The cleaned laundry order may specify the amount and type of laundry required for the room and details of the location of the room.

The soiled laundry replaced from a room of the accommodation facility may be deposited in a box that may be received by the robotic carrier which identifies the box and the content of the box and the room from which the soiled laundry is collected before transporting the box to the inventory buffer and racking system of the accommodation facility for collection by the transportation system for delivery to the cleaning centre.

The cleaning centre may identify each box received from the transportation system to identify the contents of each box and the accommodation facility from which the soiled laundry originated. The contents of each box may be deposited onto a conveyor system of the cleaning centre for sorting and the boxes may be transferred to a sanitization station for cleaning before sending the boxes to the inventory buffer and racking system of the cleaning centre. The soiled laundry items may pass through a first segregator to separate the soiled laundry items prior to passing the separated soiled laundry items through a scanner to identifying a type of item. The soiled laundry items may be cleaned based on the type of item identified.

Upon receiving the cleaned laundry order, the cleaning centre may package the cleaned laundry items according to the cleaned laundry order into a dedicated box which may be tagged to identify a type of laundry items contained therein and a destination location for the box. Upon delivery of the dedicated box to the accommodation facility, the robotic carrier may scan the dedicated box to identify the contents of the dedicated box and the destination or room to which the dedicated box is to be delivered, and may deliver the dedicated box to a designated delivery point for that room.

The conveyor system may engage with the racking system of the vehicle to load/unload the boxes. The racking system of the vehicle may comprise a plurality of bays for receiving the boxes, each bay may have at least one level.

The control system may comprise a plurality of sensor elements that detect a location of soiled laundry between the accommodation facility and a cleaning centre. The sensor elements may scan an identification tag provided with each box to determine the location of the soiled or cleaned laundry to assist in determining the availability of cleaned laundry to the accommodation facility.

Accordingly, in another aspect of the invention there is provided a laundry processing system for processing soiled laundry for a customer, comprising:
a control system for interrogating the customer to generate a cleaned laundry order in accordance with the customer's requirements;
a transportation system for collecting soiled laundry from the customer and for delivering cleaned laundry to the customer in accordance with the generated cleaned laundry order; and
a cleaning centre for receiving boxes containing the soiled laundry and for cleaning the soiled laundry and the boxes for repacking in accordance with the generated cleaned laundry order;
wherein, individual laundry items are tagged to identify the item and the cleaned boxes are repacked with items in accordance with the generated cleaned laundry order.

In one embodiment of this aspect, the customer is an accommodation facility and the control system generates a cleaned laundry order based upon check-out times for rooms in the accommodation facility. The cleaned laundry order may be based on the laundry requirements for each room that is to be vacated in a proceeding 24 hour period.

The boxes may contain the soiled laundry are generated by the customer and the boxes are tagged to identify a type of laundry item contained therein and a source location of that laundry item.

The cleaning centre may scan each box received to identify the contents of each box and the customer from which the laundry items originated. The contents of each box may be deposited onto a conveyor system for sorting and the boxes may be transferred to a sanitization station for cleaning. Following cleaning, the cleaned boxes may be transferred to a dispatch station.

The soiled laundry items may pass through a first segregator to loosen up the soiled laundry items prior to passing through a scanner for identifying the soiled laundry items. The soiled laundry items may undergo washing based on the type of item identified.

Following washing, each cleaned laundry item may be finished at a finishing station and sent to the dispatch station for packaging in a dedicated cleaned box in accordance with the generated cleaned laundry order.

A high speed manipulator may be provided to place the cleaned laundry items into the cleaned boxes.

The boxes containing soiled laundry may be tallied by the control system to generate an inventory of soiled laundry held by the cleaning centre. The boxes containing the soiled laundry may be stored in the cleaning centre.

Accordingly, in another aspect of the invention there is provided a laundry transfer system for transferring soiled laundry and cleaned laundry between a cleaning centre and a customer, comprising:
a control system for interrogating the customer to generate a cleaned laundry delivery order and a soiled laundry collection order in accordance with the customer's requirements;
a plurality of boxes, each box configured to store an order of either cleaned laundry or soiled laundry, each box having a tag for identifying the box and the contents contained therein;
a transport vehicle having a racking system contained therein, the racking system being configured to store the boxes in a controlled manner and having a reader device for reading a tag of each box to record the presence of the box with the control system;
a conveyor system configured to engage with the vehicle to facilitate loading/unloading of the racking system with the boxes;
wherein, the boxes are loaded/unloaded from the vehicle in accordance with the cleaned laundry delivery order and/or the soiled laundry delivery order.

In one embodiment, the cleaned laundry boxes are loaded from the cleaning facility in accordance with the cleaned laundry delivery order.

Upon loading of the boxes containing the cleaned laundry, each box may be scanned and recorded with the control system. The boxes containing the cleaned laundry may be loaded into the racking system of the vehicle. The racking system comprises a plurality of bays for receiving the boxes and the bays contain at least one level.

In another embodiment, the cleaned laundry boxes are loaded from the customer facility in accordance with the soiled laundry delivery order.

Upon loading of the boxes containing the soiled laundry, each box may be scanned and recorded with the control system. The boxes containing the soiled laundry may be loaded into the racking system of the vehicle. The racking system may comprise a plurality of bays for receiving the boxes and the bays contain at least one level.

Accordingly, in yet another aspect of the invention there is provided a laundry management system (LMS) for prioritizing linen cleaning in an accommodation facility comprising:
a control system comprising a central computer server capable of interrogating a property management system of the accommodation facility to generate the laundry requirements for the accommodation facility;
a laundry handling module in communication with the control system for updating the control system on the availability of cleaned linen ready for the accommodation facility and the nature and location of soiled linen associated with the accommodation facility;
wherein the control system is capable of comparing the laundry requirements of the accommodation facility against the availability of cleaned linen ready for the accommodation facility to generate a priority for processing the soiled linen to meet the laundry requirements of the accommodation facility.

The control system may comprise a plurality of sensor elements for detecting the location of soiled linen between the accommodation facility and a cleaning centre.

The soiled linen and the cleaned linen may be contained within boxes having a identification tag associated therewith.

The sensor elements may read the identification tag to determine the location of the soiled or cleaned linen to assist in determining the availability of cleaned linen to the accommodation facility.

### BRIEF DESCRIPTION OF THE DRAWINGS

The invention may be better understood from the following non-limiting description of preferred embodiments, in which:

FIG. 1 is a block diagram of the Laundry Management System (LMS) in accordance with an embodiment of the present invention;

FIG. 2 is a flow diagram depicting the method for collecting and cleaning soiled laundry items in accordance with an embodiment of the present invention;

FIG. 3 is a front view of a laundry box in accordance with an embodiment of the present invention;

FIG. 4 is a bottom view of the laundry box of FIG. 3;

FIG. 5 is a perspective view of the laundry box of FIG. 3 showing door flaps for accessing the interior of the box;

FIG. 6 is a front view of a robot for use with the system of the present invention in accordance with one embodiment;

FIG. 7 is a side view of the robot of FIG. 6;

FIG. 8 is an enlarged view showing the robot of FIG. 6 engaging with the laundry box of FIG. 3;

FIG. 9 is a first part of a flow chart depicting the steps associated with collecting soiled laundry items in accordance with an embodiment of the present invention;

FIG. 10 s a second part of the flow chart depicting the steps associated with collecting soiled laundry items in accordance with an embodiment of the present invention;

FIG. 11 is a first part of a flow chart depicting the steps associated with delivering cleaned laundry items in accordance with an embodiment of the present invention;

FIG. 12 is the second part of a flow chart depicting the steps associated with delivering cleaned laundry items in accordance with an embodiment of the present invention;

FIG. 13 is a flow chart depicting a method of operating the linen management system according to the present invention;

FIG. 14 is a flow chart depicting a method of operating the cleaning centre according to the present invention; and

FIG. 15 is a flow chart depicting a method of handling linen boxes for transportation in accordance with an embodiment of the present invention.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

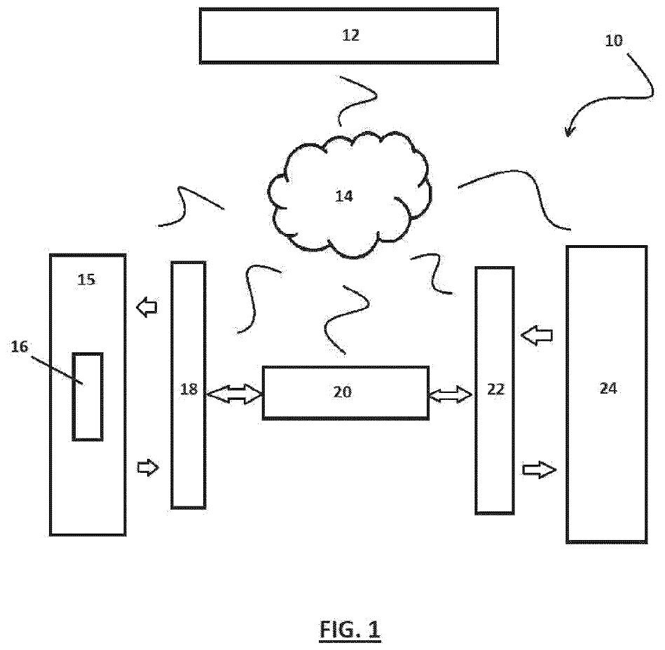

Referring to FIG. 1, the Laundry Management System (LMS) 10 in accordance with one embodiment of the present invention is shown.

The LMS 10 is controlled by a LMS control system 12 in the form of a computer server having an operating system configured to operate software to control the components of the LMS system 10 in a manner to be described in more detail below. The LMS control system 12 is in communication with a network 14, such as the internet, and is capable of sending and receiving signals from the various components of the system 10 in real time.

A hotel 15 operating a Property Management System (PMS) 16 is in electronic communication with the LMS control system 12. The PMS 16 associated with the hotel 15 may be in the form of any commercially available PMS that is capable of managing customer bookings and real-time check-in information to provide the LMS control system 12 with information as to check-in and check-out times for collecting and delivering laundry to the rooms. In use, the hotel's PMS 16 prioritises demand for housekeeping activities to be coordinated through the LMS control system 12. This includes the stock levels of linen and other laundry items allocated across the various floors of the hotel to ensure that there is sufficient stock available to meet the demands of the hotel customers. Typically, the hotel's PMS 16 will be integrated into the LMS control system 12 software to insure that all information required to operate the system 10 is co-ordinated.

A housekeeper module 18 is associated with the hotel 15 for collecting soiled laundry items for cleaning and for delivering cleaned laundry items for use, under control of the LMS control system 12. As will be described in more detail below, the housekeeper module 18 comprises a number of mobile robotic units capable of autonomously retrieving and delivering laundry items to hotel cleaning staff under the control of the LMS control system 12. The mobile robotic units are also able to deliver soiled laundry items to the transport logistics module 20, which delivers the soiled laundry items to a remote cleaning facility for cleaning.

The transport logistics module 20 typically comprises a plurality of transport units, such as trucks, vans and the like, which are equipped with scanners and GPS tracking systems to constantly provide the LMS control system 12 with data to track the location of the laundry items at all times. As the mobile robotic units of the housekeeper module 18 load the soiled laundry items into the transport units of the transport logistics module 20, or retrieve the cleaned laundry items from the transport units of the transport logistics module 20, the individual items are scanned and the data captured by the LMS control system 12. The LMS control system 12 is then able to update the inventory stored for the hotel within the server memory.

A laundry handling module 22 associated with a cleaning centre 24, retrieves the soiled laundry from the transport logistics module 20 for cleaning at the cleaning centre. As will be described in more detail below, the laundry handling module will comprise automated equipment for collecting and transporting the laundry items around the cleaning centre 24 and will include RFID sensors and other sensor equipment for tracking the laundry items and for monitoring the state of the laundry items. Such equipment will be configured to identify whether the laundry items require rewashing or destruction, based on their physical condition and state.

The cleaning centre 24 will be capable of washing and ironing the received laundry items after which the laundry handling module 22 will pack and despatch the clean laundry items for delivery to the hotel via the transport logistics module 20. The LMS Control System 12 will work in tandem with the handling module 22 to identify and prioritise work orders.

It will be appreciated that each individual item of laundry will be equipped with a RFID or similar tracking device for identifying the item and for tracking its location within the Laundry Management System (LMS) 10, in the manner as will be described in more detail below. With such a system 10, information will be shared between the hotel's PMS 16 and the LMS control system 12 to ensure that demand is met and quality of the laundry items is maintained.

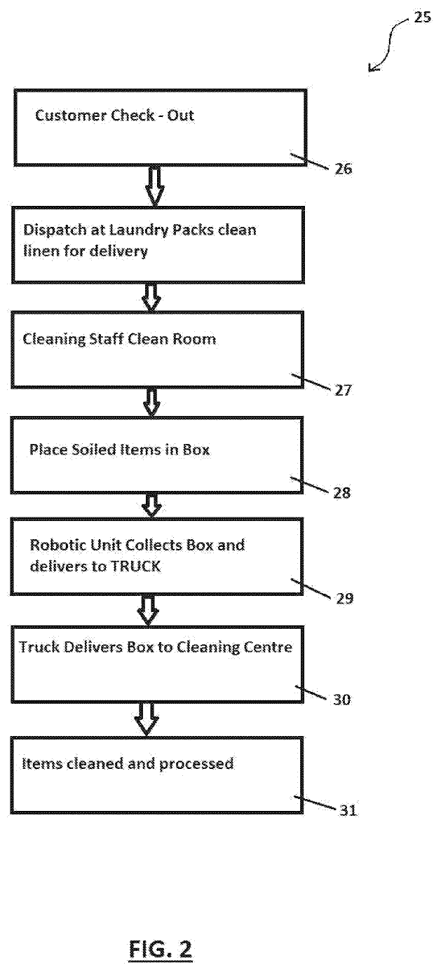

Referring to FIG. 2, a flow chart depicting a method 25 for co-ordinating collection of soiled laundry items at a hotel is shown.

As previously discussed, the hotel's PMS 16 is integrated into the software of the LMS control system 12. In this regard, a predetermined time before the customer checks-out of the hotel in step 26, which may preferably be 24 hours before checkout, the hotel's PMS 16 will trigger a demand request to clean the room, which will simultaneously create a trigger in the LMS control system 12 of the need to collect the soiled laundry items from the room being vacated.

In step 27, the cleaning staff employed at the Hotel 15 will attend the newly vacated room in accordance with the hotel's room cleaning policy. The staff will gather soiled linen and other items from the room and will place the soiled laundry items from that room in a dedicated box or cage for collection, in step 28.

In step 29, a robotic unit associated with the housekeeper module 18 will collect the box or cage containing the soiled laundry items from the newly cleaned room from a dedicated collection zone on the floor where the room is located. The robotic unit will then transport the box or cage to a truck or van located in a loading bay of the hotel 15. The box or cage will then be loaded, together with other boxes containing soiled laundry items from other rooms, onto the truck or van in a manner as will be described in more detail below.

In step 30, the van or truck delivers the cages/boxes to the cleaning centre 24. Typically, the cleaning centre 24 may be remotely located from the hotel 15, or may be positioned within or in close proximity to the hotel 15. Upon arrival at the cleaning centre, the cages/boxes will be unloaded and delivered to the relevant cleaning station for cleaning and processing in step 31, in a manner as will be discussed in more detail below.

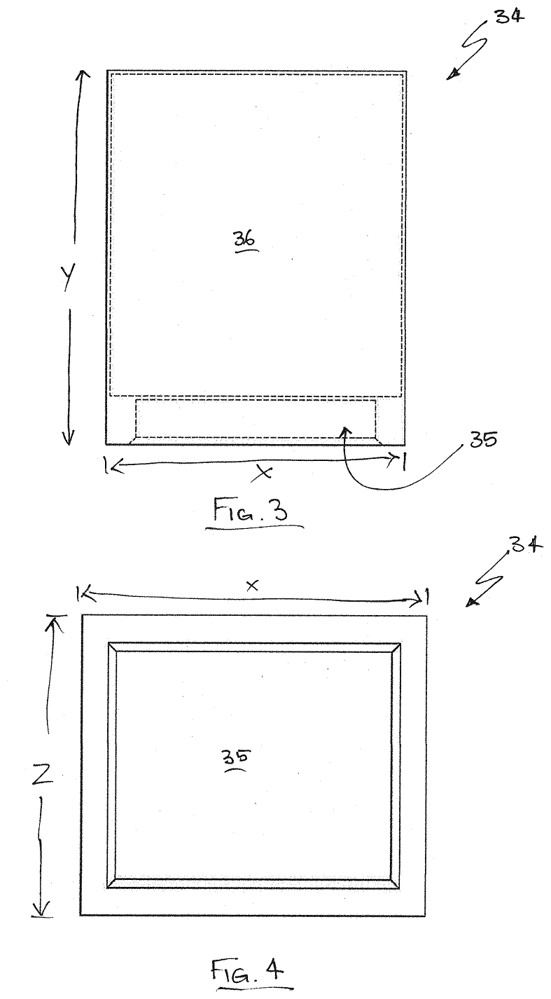

One embodiment of the storage cages/boxes 34 for use in receiving the laundry items in the present system is depicted in FIGS. 3-5. In this embodiment, each box 34 is substantially rectangular in configuration having a height ‘Y’ of around 1000 mm, a width ‘X’ of around 700 mm and a depth ‘Z’ of around 800 mm. It will be appreciated that the box 34 may have other dimensions to accommodate different types of laundry items as required.

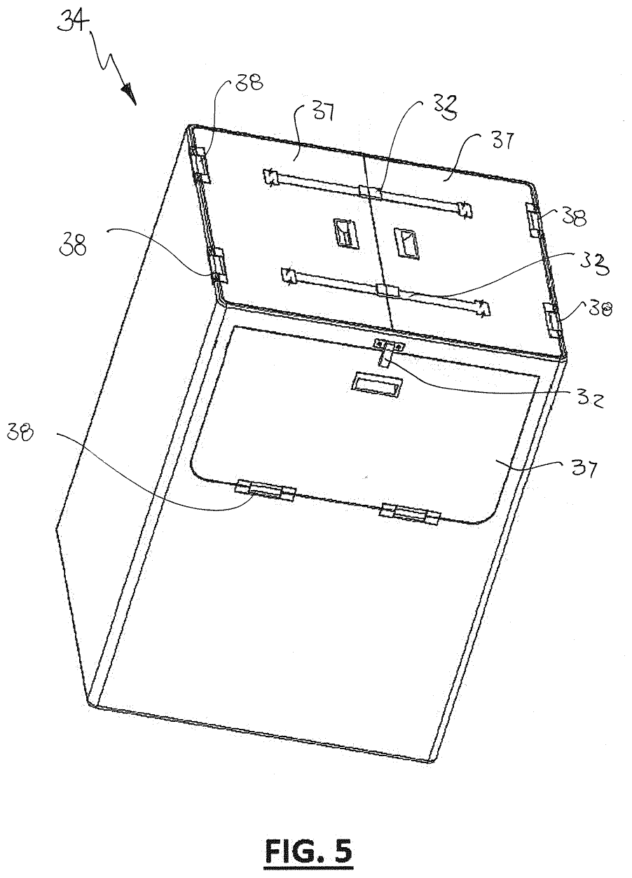

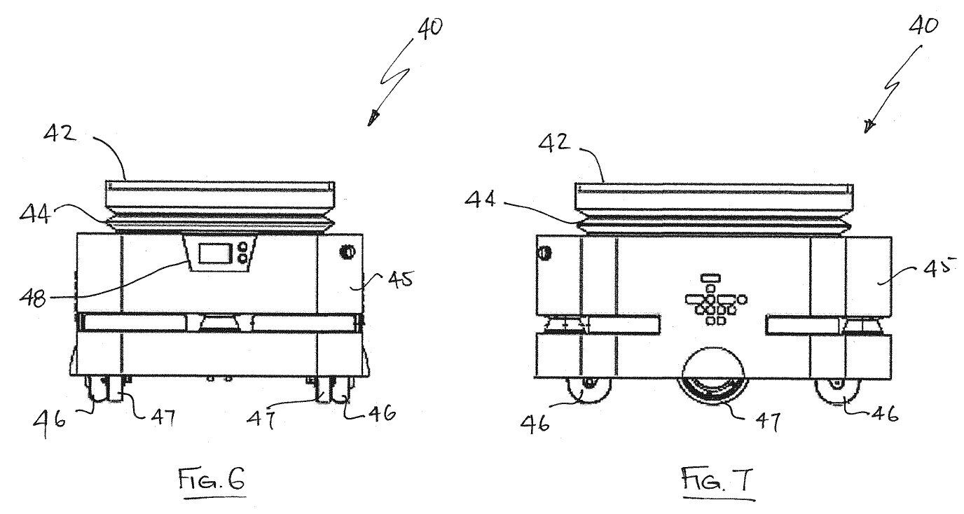

As is shown more clearly in FIG. 5, the interior 36 of each box 34 is accessible by way of doors or flaps 37. The doors or flaps 37 may be attached to the walls of the box 34 by way of hinges 38, such that they can be simply pivoted open to gain access to the interior 36. In this regard, the flaps or doors 37 may be arranged to extend across an upper surface of the box 34 when in an upright position. In this configuration, the flaps or doors 37 may automatically open when the box 34 is tipped on its side or inverted to facilitate emptying of the box 34. In another arrangement, one or more doors or flaps 37 may be attached over a recess formed in the side walls of the box 34. Similarly, these doors or flaps 37 will open when the box 34 is tipped on its side to facilitate emptying of the box 34 as desired. The doors or flaps 37 may have latch members 32 or straps 33 that can be engaged/disengaged to control the opening of the doors or flaps 37 as required. Such latch members may be configured such that they can be automatically engage/disengaged as the box is transported through a gate or station, as will be discussed in more detail below.

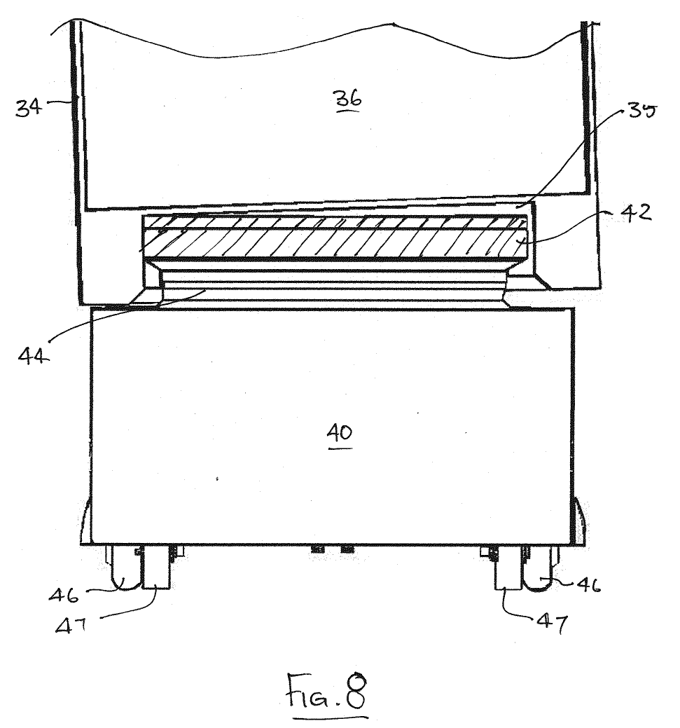

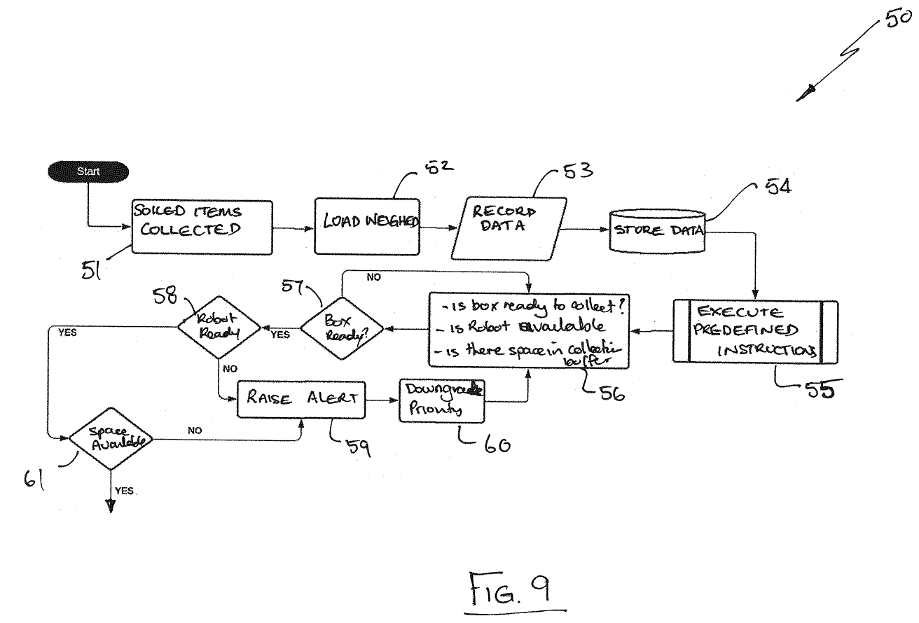

Referring to FIG. 3 and FIG. 4, an underside of the box 34 may be provided with a recess 35 formed therein to facilitate engagement of the box 34 with a robotic unit 40, as is shown in FIGS. 6 and 7. The recess 35 has a substantially rectangular configuration that mates with an engagement plate 42 provided on the robotic unit 40. The peripheral walls of the recess 35 have an angled edge 36 to aid in receiving the engagement plate 42 of the robotic unit 40.

The robotic unit 40 has a substantially rectangular body 45 upon which the engagement plate 42 is supported. The engagement plate 42 is positioned atop a lift device 44, such as a scissor-lift unit, to raise and lower the engagement plate 42 to engage with the box 34 as required. The robotic unit 40 has a controller 48 that is capable of receiving control signals from a remote controller, to control movement and position of the robotic unit 40. The robotic unit 40 hay have passive wheels 46 that support the body 45 during motion, and driven wheels 47 that propel the robotic unit and steer the robotic unit 40 to the desired location under control from the remote controller.

As is shown in FIG. 8, in step 29 of method 25 as depicted in FIG. 2, the hotel cleaning staff position the box 34 with the soiled laundry items contained therein in a dedicated collection point. The dedicated collection point is typically located on the same floor as the room that is cleaned and elevated the box 34 above the ground surface such that the robotic unit 40 is able to travel under the box 34 as is shown in FIG. 8. In this position the robotic unit 40 can activate the engagement plate 42 to raise the engagement plate to extend into the recess 35 formed in the underside of the box 34. The engagement plate is then lowered to securely support the box 34 on the robotic unit 40 as shown. In this position, the robotic unit 40 is able to transport the box 34 containing the soiled laundry items to a loading dock for further processing.

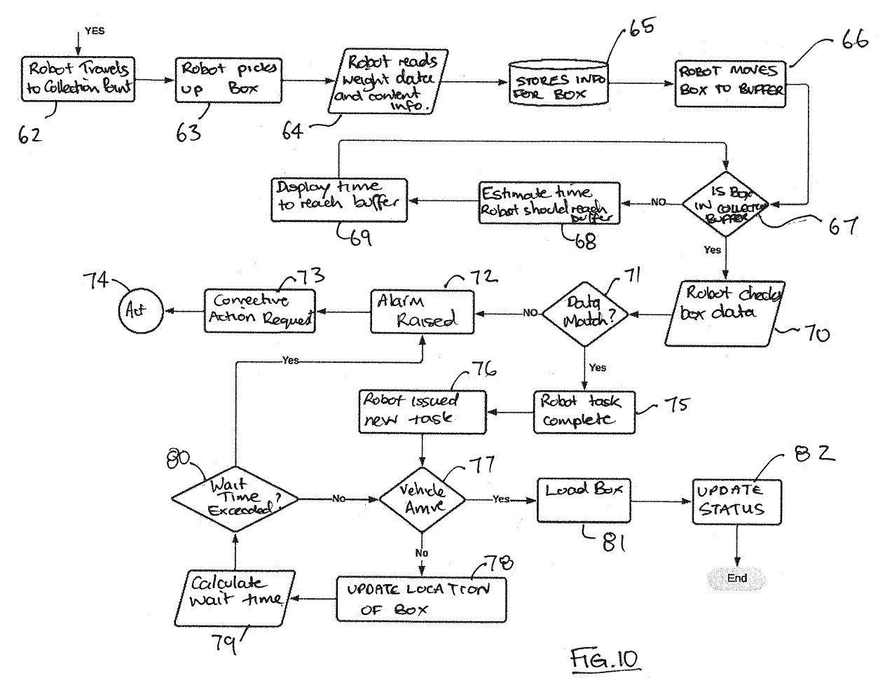

Referring to FIG. 9, a method 50 for controlling the collection of soiled laundry items in accordance with an embodiment of the present invention, is shown. As previously stated, this method may be controlled by a dedicated software component of the LMS control system 12, which may be triggered when the Hotel PMS 16 identifies a predetermined time period, namely 24 hours, prior to customer check-out.

In step 51, the cleaning staff collect the soiled laundry items from the room and place the items into the box 34 for collection. The box 34 is placed in the dedicated collection point on the relevant floor of the hotel 15. The collection point is configured to receive the box 34 within a dedicated slot such that the collection point to obtain a weight measurement of the soiled laundry in step 52, with the weight data for the box 34 recorded for that box and for the slot in the collection point. This data is also captured by the LMS control system 12 in step 54, with the LMS control system 12 being responsible for controlling the robotic units 40.

In step 55, the receipt of the data in step 54 causes the LMS control system 12 to execute a number of pre-defined instructions to initiate collection of the soiled laundry items. These instructions are processed in step 56, whereby the LMS Control system 12 determines whether the box 34 is ready for collection and whether there is a robotic unit ready to collect the box and whether there is space in the collection buffer to receive the box 34. In step 57, if the box 34 is not ready for collection, step 56 is repeated until collection is requested by the cleaning staff. Once this request has been satisfied, a determination as to whether there is a robotic unit ready to facilitate collection of the box 34 is made in step 58. If a robotic unit is not available, the system raises an alert in step 59 to investigate why there is no available robotic unit, and the priority of the request is downgraded in step 60 and the determination is reprocessed in step 56. If there is a robotic unit available for collecting the box 34, the system then determines whether there is an available space in the collection buffer for receiving the box 34 in step 61. The collection buffer may be a dedicated space in the hotel basement or another dedicated area where the boxes are kept prior to boarding the trucks/vans en route to the cleaning facility. If there is not enough space in the collection buffer, an alert is raised in step 59 and the priority of the request is downgraded in step 60 and the determination is reprocessed in step 56.

If there is space available in the collection buffer for the box, the method then proceeds to the steps depicted in FIG. 10.

In step 62, a robot is dispatched to the collection point to collect the box in step 63, in the manner as described above. At collection, the robot records the weight data for the box 34 as well as the laundry content of the box, as generated by the cleaning staff. This data is then stored in the LMS Control system 12 for the box 34, in step 65.

In step 66, the robot transports the box 34 to the collection buffer area slot designated for that box 34. In step 67, the designated collection buffer slot determines whether the robot has reached the collection buffer slot. In this regard, the collection buffer slot may comprise an RFID reader that reads a signal identified by the robot to determine when the robot arrives at the slot. If, in step 67, the collection buffer slot does not detect the presence of the robot and box 34, the LMS Control System 12 will then estimate the expected time that the robot should reach the buffer slot in step 68 and display that time in step 69. The collection buffer slot will then continue to check for the presence of the robot in step 67.

When the robot has been detected to be at the collection buffer slot in step 67, the robot then reads the identification data for the box 34 stored at the collection buffer slot in step 70. The identification data for the box 34 is the weight data and content data generated at the collection point for the box 34. If the identification data carried by the robot for the box 34 is different to that provided at the collection buffer slot in step 71, an alarm is raised regarding the error in step 72, which will request a corrective action in step 73. The corrective action will then be actioned in step 74 and the box will not be stored in the collection buffer slot until such action has been performed.

If, in step 71, the data for the collection buffer slot matches the data for the box carried by the robot, the robot will deposit the box in the collection buffer slot in step 75, completing the robot task. In step 76, the LMS control System 12 will then issue a new task to the robot to return it to the robot storage area for collecting more boxes as required.

In step 77 determination is made as to whether a vehicle is present to load the boxes in the collection buffer. If no vehicle is present, the LMS control System 12 will refresh the location status for each box 34 at the collection buffer in step 78, and will calculate the length of wait time for each box in step 79. A determination will then be made in step 80 as to whether the calculated wait time for each box has exceeded a predetermined weight time set by the LMS control System 12. If the wait time has exceeded the predetermined wait time, an alert will be activated in step 72, which will request corrective action to address the excessive weight time. If the predetermined wait time has not been exceeded, the system will continue to wait for the arrival of the vehicle.

Upon arrival of the vehicle, the vehicle collects the box from the collection buffer slot in step 81. As the box is loaded into the vehicle, it will be scanned and the location of the box will be updated in the LMS control System 12 in step 82, to ensure that all boxes are traced and can be readily located en-route to the cleaning centre. Each vehicle will be equipped with a low power scanner and GPS to capture data relating to the number of boxes carried by the vehicle, the tonnage of laundry and the type of laundry. Each of the boxes will be carried by dedicated shelving to aid in unloading when the vehicle is at the cleaning centre.

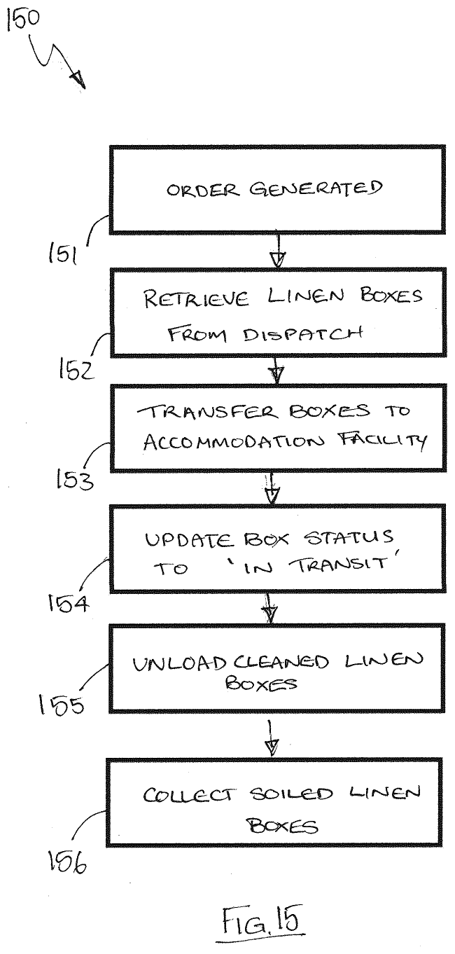

Referring to FIG. 14, a method 140 depicting how the cleaning centre processes an order is depicted.

The method 140 comprised an initial step 141 whereby the LMS control system 12 scans the hotel PMS 16 to determine the customer requirements over a 24 hour period. This may comprise interrogating the hotel's PMS 16 to scan room check-outs 24 that may occur in the next 24 hours. The LMS control system 12 will then generate an order based on linen requirements to fit out each identified room and the order will be created and sent to the commercial laundry or cleaning centre.

In step 142, the cleaning centre actives cleaning of the soiled linen received in each of the soiled boxes delivered by the delivery trucks from the customer/hotel. This is achieved in the manner as described below.

The cleaning centre contains five main sections: a pre-sorting section; scan sorting section; scheduled processing section; finishing section; and dispatch.

### Pre-Sorting Section

The pre-sorting section functions to load and segregate the laundry items present in the boxes upon arrival at the cleaning centre. Upon arrival at the cleaning centre, each of the boxes are located on the dedicated shelving where they will be transferred to a rail system. Upon loading onto the rail system, each box is scanned to identify the contents of each box and the hotel name from which the laundry items originated. The boxes will then travel along the rail system to a point where they will be tipped over and the laundry items will be unloaded through the doors formed in the boxes, as previously discussed. The laundry items will be then located on a conveyor pallet to be delivered to the appropriate station for cleaning.

In step 143, the empty boxes that contained the soiled laundry are moved to a sanitizing facility with the cleaned boxes to be transported to a dispatch area for repacking.

In step 142, the unloaded laundry items pass through a first segregator to loosen up the items and any items that remain in a bulk state are redirected to a station for manual unloading and separation. All loosened items will then travel along a sensor controlled conveyor to the scan sorting section.

### Scan Sorting Section

All laundry items received by the Scan Sorting Section pass through a visual scan system to identify the orientation of the item. Articulated or parallel items will select an item at a time to place into an x-ray scanner box to segregate and items that may contain foreign objects. Any laundry item without any foreign objects will then be RFID scanned to identify the item type, with each item bagged together according to its type. The sorted laundry items will then be stored in a pre-wash inventory system and all laundry items with foreign objects will be redirected to a manual removal station.

### Scheduled Processing Section

The cleaning centre will have a scheduled system for processing the laundry items. All laundry items will undergo washing based on the type of item and following washing each item will be pressed before transportation to a tumble dryer. Following drying all items will be unloaded onto a conveyor system and a vacuum handling system will be deployed to transport and distribute the items to respective areas for finishing and for manual handling, such as turning pillow cases and doona covers inside out, as required. The Scheduled Processing Section may be controlled by a management system whereby scheduling of the various processes may be influenced based on capacity as well as, priority customers and the like.

### Finishing Section

In step 144, the cleaned laundry items are processed at a Finishing Section that provides various finishing options depending on the type of finishing required for each cleaned item of laundry. For towels, the dried towels will be transferred to a towelling line conveyor via a vacuum suction pipeline. The towels will pass through a cleaning device, where each towel will be feed into towel folder and folded. Inline cameras will be used to screen out any stained items prior to loading into the towel folder and small towels, such as face washers, can be identified by vision assisted robotics, laid flat, bundled and scanned. The folded towels will then be bundled, packed and RFID scanned before being transferred into storage basket for return.

Completed “wet” items will be transferred to an iron line conveyor via a vacuum suction pipeline. As the items are “loose”, vision assisted robotics will be deployed to pick up one corner of each sheet. As the ironer clip moves upward along the roller, the second corner of the sheet will be captured on a camera and a second ironer clip will hold the 2nd corner. The single piece of sheet will then be transferred to an ironer clip with a roller on a slanted/angled rail. The clipped sheet will be lined up in the storage area to be fed into the ironer and cameras located in the ironer will identify any stained items which will be removed and disposed of. The folded and ironed linen will be bundled, packed and RFID scanned before being placed in the storage basket for dispatch.

As alluded to above, other items such as pillow cases and doona covers will be transferred to a manual handling line for processing. Any inside-out covers will be undone manually and feed back into the system individually. The single piece of doona cover can either hand feed to clipper rail or fed like the sheeting section. Similarly, pillow cases can be either manual feed to the ironer to lay the pillow cases flat before feeding to ironers. All folded linen will be bundled, packed and RFID scanned before being placed to the storage basket for dispatch.

### Dispatch

In step 145, bundled linen will exit to a final output station where a high speed manipulator will place the linen into storage baskets with smart ID tags. The smart ID tags are used to identify content of each storage basket in accordance with the order generated in step 141. Where there is excess linen, the storage basket will be placed into a shelving system and if there is an immediate demand for the linen, the storage basket will be transferred to the dispatch port where a robotic device will move the linen from the baskets into the dedicated boxes. Once the boxes are created to fulfil the required orders, the boxes will travel on a rail system to line up for dispatch. For all prepared boxes, a docket will automatically print off for the driver to send out with the dispatch.

In step 146, the vehicles collect the prepared boxes which have an RFID tag to identify the contents where the boxes are delivered to the customer within the pre-agreed time period for processing by the hotel.

The method 150 in which the boxes containing the cleaned laundry items are handled by the transportation system of the present invention is described in relation to FIG. 15.

In step 151, the LMS control system 12 scans the hotel PMS 16 to determine the customer requirements over a 24 hour period. This may comprise interrogating the hotel's PMS 16 to scan room check-outs 24 that may occur in the next 24 hours. The LMS control system 12 will then generate an order based on linen requirements to fit out each identified room and the order will be created and sent to the commercial laundry or cleaning centre. Following the order being processed, a box containing the cleaned linen in accordance to the order is provided at the dispatch zone of the cleaning centre 24 for collection by the transport system, namely a truck, van or the like.

The truck or van is fitted with a racking system comprising a plurality of dedicated spaces to receive the boxes 34, such as that depicted in FIG. 5. The racking system comprises a plurality of bays arranged in rows which receive the boxes that are free to slide in the bays along rollers or similar mechanisms. The bays comprises a hydraulic lifting mechanism, or the like, such that each bay comprises a plurality of levels to store the boxes therein.

In step 152, upon arrival of the van or truck at the dispatch zone, the driver or operator checks the LMS control system 12 to identify the boxes to be loaded for delivery to the customer. The LMS control system will provide the driver with a list of the boxes and their ID tag and the driver will attach a flexible mobile conveyor to their van or truck to provide access to the racking system contained in the van or truck. The operator will then retrieve the boxes containing the cleaned linen in accordance with the ID tags provided by the LMS control system and the identified boxes will be loaded onto the racking system of the vehicle and a tag reader will record the box as it is loaded and update the LMS Control system accordingly. The driver or operator will then be updated as to when all the required boxes have been loaded into the vehicle.

In step 153, the vehicle, after loading all the boxes containing the cleaned linen will transfer to the accommodation facility for delivery.

In step 154, during transit of the vehicle to the accommodation facility, the LMS Control System will update the status for each order as being “in transit”.

In step 155, upon arrival of the vehicle at the loading bay of the accommodation facility, the driver will connect an on-site flexible conveyor to the vehicle and boxes containing the cleaned linen will be unloaded from the racking system of the vehicle via the flexible conveyor, into dedicated collection bays provided in the loading bay. As each box is unloaded into the loading bay from the vehicle, the tag for each box will be scanned and the location of the box will be updated in the LMS control system. The robotic units 40 will then be activated to collect the boxes and deliver them to their appropriate destination in the manner as described in more detail below.

In step 156 the driver will then load any soiled linen boxes required for cleaning as requested by the hotel's PMS. Once loaded into the racking system of the vehicle, the soiled linen boxes will be scanned and recorded with the LMS Control System as being collected and the driver will return to the cleaning centre to unload the soiled linen boxes where they will be tallied and recorded. The soiled linen will then be cleaned and processed as previously described.

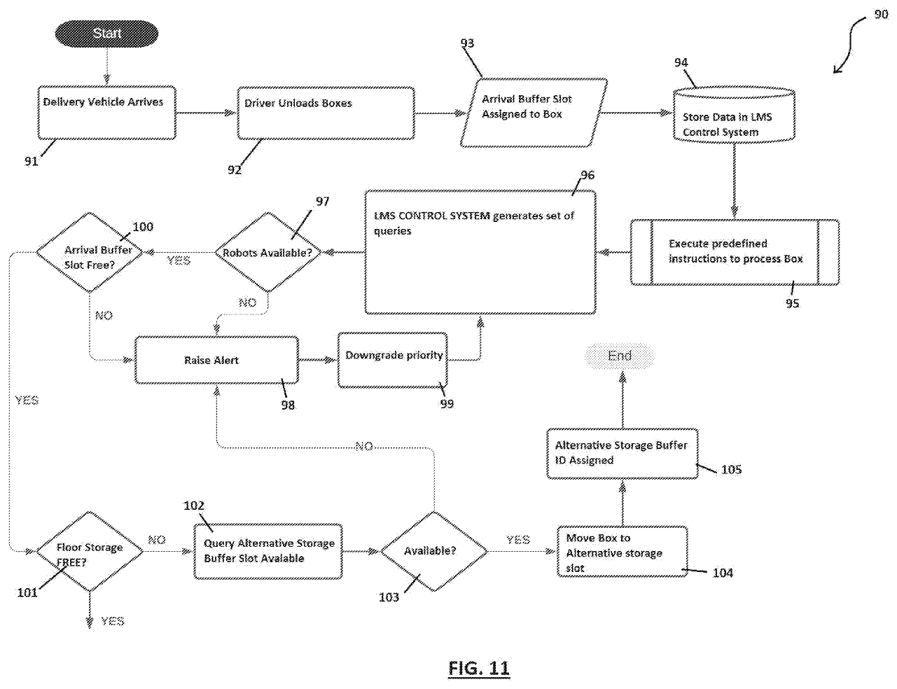

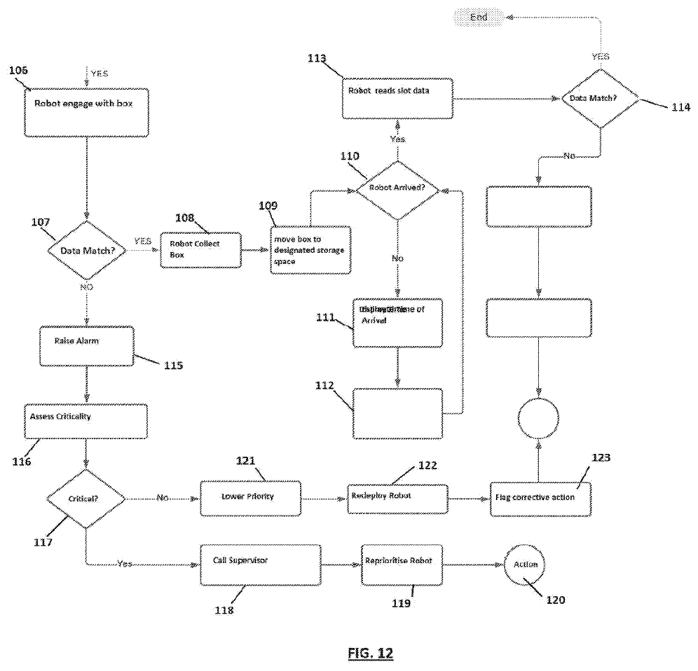

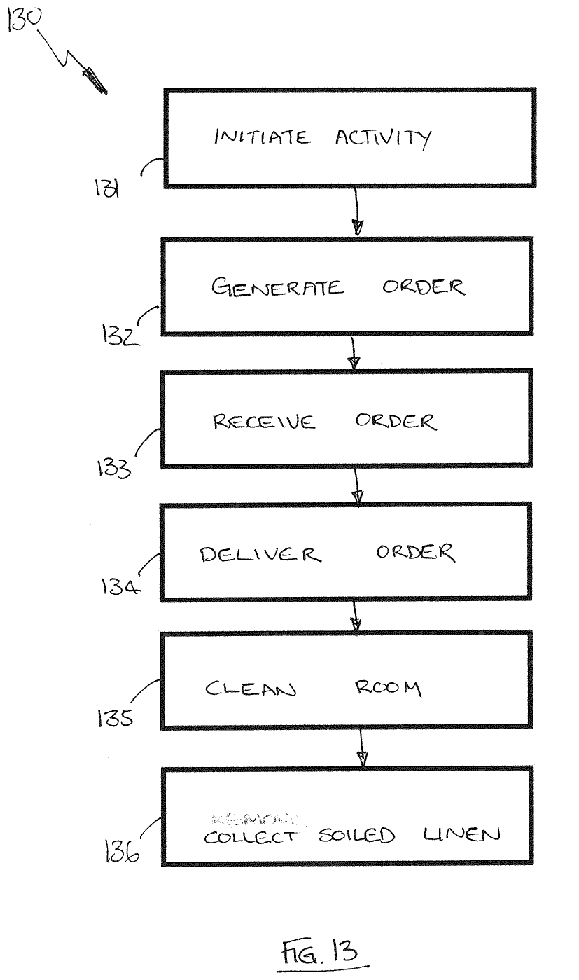

The method 90 upon which the cleaned laundry items are processed upon delivery to the Hotel is depicted in FIG. 11 and FIG. 12.

In step 91, the delivery vehicle arrives at the Hotel loading bay with the cleaned laundry items contained in dedicated boxes. Upon arrival, in step 92 the driver rolls out the boxes from the vehicle onto a dedicated arrival buffer zone provided at the Hotel. The arrival buffer zone is provided with scanners that read the box identification data for each box and assigns an arrival buffer slot to locate the box in step 93. This data is then stored in the LMS Control System 12 in step 94, which causes the LMS Control System 12 to execute predefined instructions to facilitate processing of the boxes in step 95.

The LMS Control System 12 then generates a set of queries in step 96 to identify that there are sufficient robots ready to move the boxes; there are sufficient arrival buffer slots to accommodate each box; there is sufficient floor storage space to accommodate the boxes; and there is sufficient laundry items to meet the Hotel's demands.

In step 97 the LMS Control System 12 determines whether there is an available robots to process the box. If there is not an available robot, an alert is raised in step 98 and the system will downgrade the priority of the box and re-do the set of queries. If there is an available robot, the system will then assess whether the arrival buffer slot is free to receive the box in step 100. Similarly, if the dedicated arrival buffer slot is not free, the system will raise an alert in step 98 and the system will downgrade the priority of that action and re-do the set of queries in step 96.

If the system determines that the arrival buffer slot is free, the system will then determine whether the dedicated floor storage system is free to receive the assigned box, in step 101. If the floor level storage system is not free, the system will then query, in step 102, whether there is an alternative storage buffer slot available in the basement of the hotel for storing the box until the floor level storage system becomes free. If the system identifies that no such alternative storage slot us available in step 103, an alarm will be triggered in step 98 and the action will have a downgraded priority and the system will re-do the set of queries in step 96. However, if there is an alternative storage buffer slot available, the robot will be directed to move the box to the identified alternative storage slot in step 104 and the box will be provided with an alternative storage buffer ID to identify the location of the box.

Referring to FIG. 12, if the system identifies that a robot is free and there is a free slot in the arrival buffer and there is a storage slot available in the floor level storage system, for the box, the robot is directed to engage with the box and to move to the arrival buffer slot and verify the data contents of the box with the arrival buffer slot data requirements, in step 106. If the data matches, the robot will pick up the box in step 108 and move the box to the designated floor level storage space in step 109.

In step 110, the system will continually monitor the floor level storage slot designated for that box to determine the arrival of the robot at the floor level storage slot. If the robot doesn't arrive within a predetermined time period, the system will estimate a cycle time for the robot to reach the floor level storage slot from its dispatch point in step 111 and the time will be displayed on the dashboard. Once the robot arrives at the floor level storage slot the robot will read the slot content data for the slot in step 113. If the data of the box matches the slot content data in step 114, the robot will deliver the box into the slot and return to its dedicated dispatch point.

If, in step 107, the content data of the box does not match the data of the arrival buffer slot, an alarm will be raised in the system in step 115 and the LMS control system will assess the criticality of the action in step 116.

If the LMS Control System 12 considers that the action is critical, namely the laundry items present in the box do not match the requirements for the box intended for that arrival buffer slot, then the system will trigger a call to a supervisor for immediate action in step 118. This will then trigger the robot assigned to that box to be reprioritised in step 119, awaiting the supervisor action in step 120.

Alternatively, if in step 117 the LMS Control System 12 considers that the action is not critical, the priority of the action will be dropped to a lower priority in step 121 and the robot will be redeployed to another task in step 122 whilst a corrective action request is flagged in step 123.

It will be appreciated that the method 90 for handling the cleaned laundry items returning to the hotel ensures that the boxes are returned to the floor storage slots such that the cleaning staff attending to the rooms are provided with clean laundry items that suit the requirements of the room. The robots are able to simply and effectively check, prior to delivery of the box that the data contents match the requirements to ensure that errors are minimised and that there is a seamless processing of soiled and cleaned laundry.

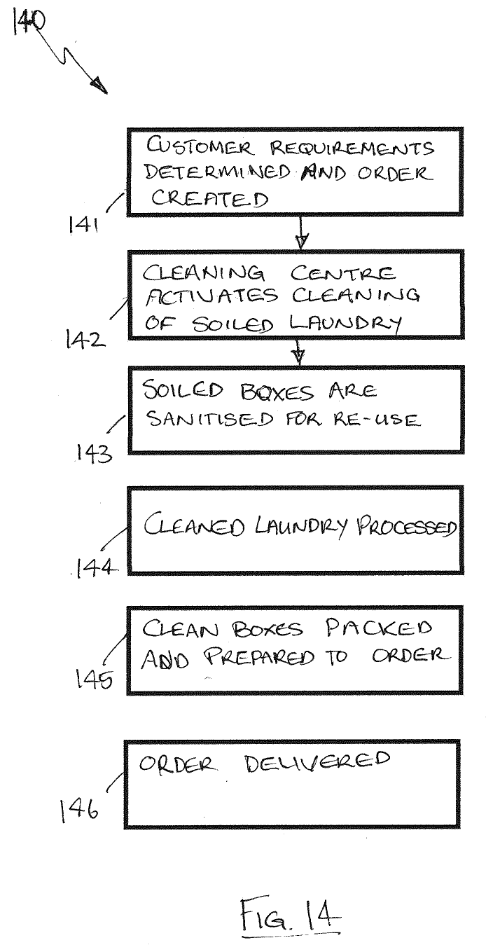

Referring to FIG. 13, the linen management system (LMS) described above is depicted to show the manner in which the flow of linen is controlled in the accommodation environment in accordance with a preferred method 130.

In step 131, an action is initiated by the hotel's PMS, which triggers an action based on a predetermined time prior to a guest checking out of a room. In a preferred embodiment, the predetermined time that triggers the action being initiated is 24 hours prior to checkout.

In step 132, an order is generated by the LMS based upon the action triggered by the PMS in step 131. The order will specify the amount and type of linen required for that room and the details of the location of the room where the cleaned linen is to be delivered. The cleaning centre will then be sent the generated order for action.

In step 133, the cleaning centre receives the order from the LMS and packs a box containing the required linen, which is tagged for delivery to the designated delivery destination.

In step 134, the packed box is delivered to the hotel at an agreed time where it will be scanned and received by a robotic unit at the hotel and delivered to the designated destination adjacent the room to be processed. This will occur on the day of check out, prior to the check out.

In step 135, following delivery of the box with cleaned linen, the housekeeping staff will clean the room and replace the linen with the cleaned linen delivered for that room. The soiled linen from the room will then be deposited in separate boxes tagged for that room.

In step 136, the soiled linen in the tagged boxes will be collected by the robotic units. The robotic units will store the soiled linen information within the LMS together with the identification tag of the box, where it will be delivered to a collection point for pick-up by the trucks for delivery to the cleaning centre for cleaning.

In the above-described method 130, the automated equipment used to distribute the clean linen to the designated storage area will also be used as a linen porting vehicle that follows the housekeeper and/or delivers the clean linen to the caller's location, including collecting soiled linen as and when the soiled linen is removed from the room.

The system of the present invention is able to integrate into a hotel's customer bookings system to provide advance forecast of linen requirements, and real time customer check-in triggers real time demand. The hotel's cleaning system is able to prioritize demand for staff actions as there is no requirement for staff to carry materials between floors and linen stocks are transparent with linen allocation balanced across all floor levels. Similarly, the collection of soiled linen and cleaned linen delivery are tracked by RFID scanners present in the vehicles such that the cleaning centres can perpetually diagnose customer's demand on real time and prioritizes linen cleaning processes to suit. Dispatch is packed based on predictive demands (customer's check-in) vs Hotel demands (real time) and the return of clean linen is distributed by robots in an automated manner.

It will be appreciated that the present invention provides a simple yet effective solution to laundry management that minimises human intervention and utilises existing knowledge of customer requirements in hotel situations. The system and method of the present invention seeks to employ a combination of advance robotics, RFID system and delivery tools to substantially improve efficiency of linen management in a hospitality setting.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

It will be appreciated by those skilled in the art that many modifications and variations may be made to the methods of the invention described herein without departing from the spirit and scope of the invention.

1. A laundry management system (LMS) for an accommodation facility comprising:
an accommodation management system for controlling movement of soiled and cleaned laundry within the accommodation facility;
a control system for interrogating a property management system of the accommodation facility to generate a cleaned laundry order in accordance with accommodation requirements of the accommodation facility;
a plurality of boxes, each box configured to store an order of either cleaned or soiled laundry, each box having a tag for identifying the box and the contents of the laundry contained therein;
a transportation system for collecting soiled laundry from the accommodation facility and for delivering cleaned laundry to the accommodation facility in accordance with the generated cleaned laundry order, the transportation system comprising at least one transport vehicle having a racking system contained therein, the racking system being configured to receive the boxes in a controlled manner and having a reader device for reading a tag of each box to record the presence of the box with the vehicle;
a conveyor system configured to engage with the vehicle to facilitate loading/unloading of the boxes from the racking system of the vehicle;
a cleaning centre for receiving boxes containing soiled laundry and for cleaning the soiled laundry and the boxes and for repacking the boxes with cleaned laundry, whereby individual cleaned laundry items are tagged to identify the cleaned laundry items in the repacked boxes in accordance with the generated cleaned laundry order;
an inventory buffer and racking system located at both the cleaning centre and the accommodation facility to receive the boxes, wherein the inventory buffer and racking system comprises one or more robotic carriers to facilitate movement of the boxes from the inventory buffer and racking system and within the accommodation facility.

2. A laundry management system according to claim 1, wherein the cleaned laundry order is generated by the control system at a predetermined time period before a room of the accommodation facility is to be vacated.

3. A laundry management system according to claim 2, wherein the predetermined time period is 24 hours.

4. A laundry management system according to claim 2, wherein the cleaned laundry order specifies the amount and type of laundry required for the room and details of the location of the room.

5. A laundry management system according to claim 1, wherein the soiled laundry replaced from a room of the accommodation facility is deposited a box that is received by the robotic carrier which identifies the box and the content of the box and the room from which the soiled laundry is collected before transporting the box to the inventory buffer and racking system of the accommodation facility for collection by the transportation system for delivery to the cleaning centre.

6. A laundry management system according to claim 1, where in the cleaning centre identifies each box received from the transportation system to identify the contents of each box and the accommodation facility from which the soiled laundry originated.

7. A laundry management system according to claim 6, wherein the contents of each box is deposited onto a conveyor system of the cleaning centre for sorting and the boxes are transferred to a sanitization station for cleaning before sending the boxes to the inventory buffer and racking system of the cleaning centre.

8. A laundry management system according to claim 7, wherein the soiled laundry items pass through a first segregator to separate the soiled laundry items prior to passing the separated soiled laundry items through a scanner to identifying a type of item.

9. A laundry management system according to claim 8, wherein the soiled laundry items are cleaned based on the type of item identified.

10. A laundry management system according to claim 1, wherein upon receiving the cleaned laundry order, the cleaning centre packages cleaned laundry items according to the cleaned laundry order into a dedicated box which is tagged to identify a type of laundry items contained therein and a destination location for the box.

11. A laundry management system according to claim 10, wherein upon delivery of the dedicated box to the accommodation facility, the robotic carrier scans the dedicated box to identify the contents of the dedicated box and the room to which the dedicated box is to be delivered and delivers the dedicated box to a designated delivery point for that room.

12. A laundry management system according to claim 1, wherein the conveyor system engages with the racking system of the vehicle to load/unload the boxes.

13. A laundry management system according to claim 12, wherein the racking system of the vehicle comprises a plurality of bays for receiving the boxes, each bay having at least one level.

14. A laundry management system according to claim 1, wherein the control system comprises a plurality of sensor elements that detect a location of soiled laundry between the accommodation facility and a cleaning centre.

15. A laundry management system according to claim 14, wherein the sensor elements scan an identification tag provided with each box to determine the location of the soiled or cleaned laundry to assist in determining the availability of cleaned laundry to the accommodation facility.
